(19) United States
(12) Patent Application Publication
(10) Pub. No.: US 2015/0339284 A1
(43) Pub. Date: Nov. 26, 2015

(54) DESIGN MANAGEMENT APPARATUS, DESIGN MANAGEMENT METHOD, AND NON-TRANSITORY COMPUTER READABLE MEDIUM

(71) Applicant: FUJI XEROX CO., LTD., Tokyo (JP)

(72) Inventor: Masashi BAN, Kanagawa (JP)

(73) Assignee: FUJI XEROX CO., LTD., Tokyo (JP)

(21) Appl. No.: 14/658,737

(22) Filed: Mar. 16, 2015

(30) Foreign Application Priority Data
May 26, 2014 (JP) 2014-108404

(51) Int. Cl. G06F 17/24; G06F 17/21

(52) U.S. Cl. CPC G06F 17/248; G06F 17/211

(57) ABSTRACT

A design management apparatus includes a management unit and an output unit. The management unit manages a history regarding plural design templates which have been viewed by a user. Each of the plural design templates is associated with plural design feature information items that indicate plural types of features in design. The output unit outputs a recommended design template in accordance with the history. The recommended design template is a design template having feature values which are between feature values of the plural types of features indicated by the plural design feature information items associated with the plural design templates which have been viewed by the user.

### CROSS-REFERENCE TO RELATED APPLICATIONS

This application is based on and claims priority under 35 USC 119 from Japanese Patent Application No. 2014-108404 filed May 26, 2014.

### Background

(i) Technical Field

The present invention relates to a design management apparatus, a design management method, and a non-transitory computer readable medium.

(ii) Related Art

Technology for creating designs of leaflets, advertisements, direct mails, posters, catalogs, and postcards, for example, is available.

Designs are sometimes created in the following manner. A user selects a design template from among plural different design templates prepared in advance and edits the selected design template.

### SUMMARY

According to an aspect of the invention, there is provided a design management apparatus including a management unit and an output unit. The management unit manages a history regarding plural design templates which have been viewed by a user. Each of the plural design templates is associated with plural design feature information items that indicate plural types of features in design. The output unit outputs a recommended design template in accordance with the history. The recommended design template is a design template having feature values which are between feature values of the plural types of features indicated by the plural design feature information items associated with the plural design templates which have been viewed by the user.

### BRIEF DESCRIPTION OF THE DRAWINGS

An exemplary embodiment of the present invention will be described in detail based on the following figures, wherein:

FIG. 1 is a block diagram illustrating a design management system according to an exemplary embodiment of the present invention;

FIG. 2 illustrates a screen displaying plural design templates;

FIG. 3 illustrates an attribute information table for design templates;

FIG. 4 illustrates a design feature map;

FIG. 5 illustrates a viewing history table;

FIG. 6 illustrates a design feature map; and

FIG. 7 illustrates a screen displaying recommended design templates.

### DETAILED DESCRIPTION

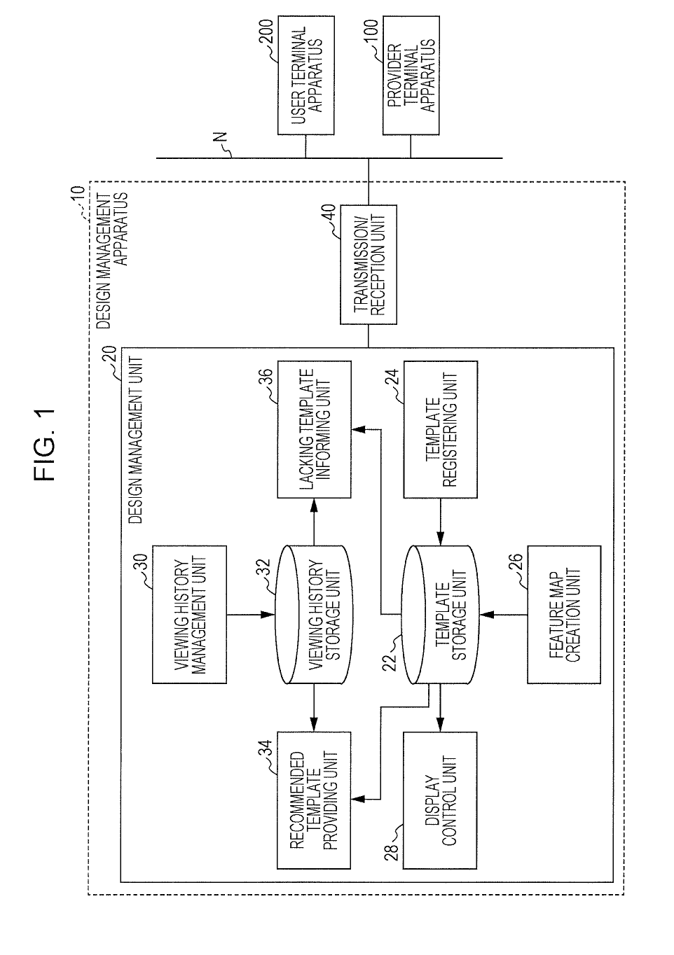

FIG. 1 illustrates an example of a design management system according to an exemplary embodiment of the present invention. The design management system according to the exemplary embodiment includes a design management apparatus 10, a provider terminal apparatus 100, and a user terminal apparatus 200, for example. The design management apparatus 10 according to the exemplary embodiment is connected to the provider terminal apparatus 100 and the user terminal apparatus 200 via a communication path N such as a network, for example.

In the example illustrated in FIG. 1, one provider terminal apparatus 100 and one user terminal apparatus 200 are connected to the design management apparatus 10 via the communication path N. However, multiple provider terminal apparatuses 100 and multiple user terminal apparatuses 200 may be connected to the design management apparatus 10 via the communication path N.

The design management apparatus 10 stores design templates (design template data) from which a design is created and has a function for providing design templates to a user in response to a user request. The design management apparatus 10 also has a function for exchanging data with the provider terminal apparatus 100 and the user terminal apparatus 200.

The provider terminal apparatus 100 is a terminal apparatus used by a provider who provides design templates. The provider terminal apparatus 100 has a function for exchanging data with the design management apparatus 10. A design template is created by a provider, is transmitted from the provider terminal apparatus 100 to the design management apparatus 10, and is stored in the design management apparatus 10.

The user terminal apparatus 200 is a terminal apparatus used by a user who creates a design by editing a design template. The user terminal apparatus 200 has a function for exchanging data with the design management apparatus 10. Design templates are transmitted from the design management apparatus 10 to the user terminal apparatus 200 and are displayed on a display unit of the user terminal apparatus 200. Then, one of the design templates is edited by the user.

The provider terminal apparatus 100 and the user terminal apparatus 200, such as personal computers (PCs), tablet PCs, smartphones, or mobile phones, have an operation unit such as a keyboard and a mouse, a display unit that functions as a display, a transmission/reception unit that functions as a network interface, and a control unit including a central processing unit (CPU).

In the design management system according to the exemplary embodiment, for example, a design template is transmitted from the provider terminal apparatus 100 to the design management apparatus 10 and is registered in the design management apparatus 10. In response to a user request, design templates are transmitted from the design management apparatus 10 to the user terminal apparatus 200. The user terminal apparatus 200 edits one of the design templates in accordance with a user operation and creates a design component.

Note that the provider terminal apparatus 100 and the user terminal apparatus 200 may be included in the design management apparatus 10.

The design management apparatus 10 will be described below. The design management apparatus 10 includes a design management unit 20 and a transmission/reception unit 40.

The design management unit 20 stores plural design templates and has a function for providing design templates in response to a user request.

The transmission/reception unit 40 is a network interface. The transmission/reception unit 40 has a function for exchanging data with the provider terminal apparatus 100 and the user terminal apparatus 200. For example, the transmission/reception unit 40 receives design templates from the provider terminal apparatus 100 via the communication path N and outputs the design templates to the design management unit 20. The transmission/reception unit 40 also transmits design templates to the user terminal apparatus 200 via the communication path N.

Individual components of the design management unit 20 will be described below.

A template storage unit 22 stores data of plural different design templates (i.e., design template data). A design template is template data of a design of leaflets, advertisements, direct mails, posters, catalogs, and postcards, for example.

For example, a design template includes one or plural design components (or design component data or objects). Examples of design components include title character components, body character components, image components, and figure components. An image component is, for example, bitmap-format image data. A figure component is, for example, vector-format figure data. A design template is data including image data, figure data, text data, information concerning a size of each data, and information concerning data arrangement.

When a design template is edited, a user edits individual design components by using the user terminal apparatus 200. Note that the term “editing a design component” refers to processing and changing a design component. For example, as for a title character component or a body character component, a character string, a font type, a font size, a color of characters, and an arranged position of characters are edited by a user. As for an image component, a design, a type, a size, and an arranged position of an image are edited by a user. As for a figure component, a color, a transparency (shading), a size, and an arranged position of a figure are edited by a user. Through editing of such design components, a design of a design template is edited and new design components are created. That is, the design management system according to the exemplary embodiment allows a user to create new design components from a design template.

A design template is associated with template attribute information in advance. The template attribute information includes, for example, template identification information, creation-date-time information, registration-date-time information, access right information, and plural design feature values.

The template identification information, for example, an ID or a design name, is information that identifies a design template. The creation-date-time information indicates the date and time at which the design template has been created. The registration-date-time information indicates the date and time at which the design template has been registered in the design management apparatus 10. The access right information identifies users who are permitted to use the design template, for example.

A design feature value is a value indicating a feature of the design of the design template (design evaluation value). Attribute information of each design template includes plural design feature values of plural types of features. A design feature value is a predetermined value and is, for example, a value decided upon by a provider of the design template. For example, a design feature value may be a numerical value indicating the lightness (brightness or darkness) of color of the design, a numerical value indicating the size of the largest character used in the design, a numerical value indicating the impact given by a combination of colors included in the design, a numerical value of a proportion of color tones of the design, and a numerical value indicating the font type used in the design. Note that the design feature value is not limited to these particular examples, and other types of information representing features of the design of design templates may be used as the design feature value.

The template identification information, the creation-date-time information, the access right information, and the design feature values are created by the provider terminal apparatus 100, for example, and are transmitted from the provider terminal apparatus 100 to the design management apparatus 10 along with the design template. The registration-date-time information is created by the design management unit 20, for example.

A template registering unit 24 is supplied with the design template and the template attribution information transmitted by the provider terminal apparatus 100 and stores the design template and the template attribute information in the template storage unit 22 in association with each other.

A feature map creation unit 26 creates a design feature map on which individual design templates are mapped in accordance with plural design feature values included in template attribute information of the individual design templates. A design feature map is a map defined by two or more axes. For example, the design feature map is a two-dimensional map defined by a first axis which represents the “lightness of color” of the design and a second axis which represents the “impact” of the design. The feature map creation unit 26 maps a design template having certain design feature values at a position (coordinates) corresponding to the design feature values on the two-dimensional design feature map. The design feature map is stored in the template storage unit 22. The design feature map will be described in detail later.

A display control unit 28 performs control so as to display design templates stored in the template storage unit 22 on the user terminal apparatus 200. The display control unit 28 has a function for causing the user terminal apparatus 200 to display thumbnail images (reduced-size images) of plural design templates, a function for causing the user terminal apparatus 200 to display a design template selected by a user, and a function for causing the user terminal apparatus 200 to arrange and display plural design templates selected by a user, for example. Specifically, the display control unit 28 transmits design templates or thumbnail images to be displayed and display information to the user terminal apparatus 200 via the transmission/reception unit 40. The user terminal apparatus 200 displays the design templates or the thumbnail images on the display unit in accordance with the display information. Note that thumbnail images of design templates may be created in advance and stored in the template storage unit 22 or may be created from the design templates by the display control unit 28 before the thumbnail images are displayed.

The display control unit 28 may have a function for transmitting the template attribution information of the design templates to be displayed to the user terminal apparatus 200 via the transmission/reception unit 40 so as to cause the user terminal apparatus 200 to display the template attribution information.

The display control unit 28 may also have a function for searching for design templates so as to cause the user terminal apparatus 200 to display the retrieved design templates. For example, a search keyword is entered and a search instruction is given to the user terminal apparatus 200. In response to the search instruction, information indicating the search keyword and the search instruction is transmitted from the user terminal apparatus 200 to the design management apparatus 10. The display control unit 28 retrieves design templates that match the search keyword from the template storage unit 22 and transmits the design templates to the user terminal apparatus 200 via the transmission/reception unit 40. The user terminal apparatus 200 then displays the received design templates on the display unit. Note that the display control unit 28 may cause the user terminal apparatus 200 to display thumbnail images of the retrieved design templates.

A viewing history management unit 30 manages a viewing history regarding design templates that have been viewed by each user and stores viewing history information which represents the viewing history in a viewing history storage unit 32. The viewing history information includes, for example, user identification information that identifies a user, user attribute information indicating business which the user is in, information indicating the date and time at which the operation has been started, information indicating the date and time at which the operation has ended, template identification information that identifies design templates that have been viewed by the user, information indicating the viewing order, and template identification information that identifies a design template finally selected and used by the user (as an editing target). For example, the user views design templates by using the user terminal apparatus 200. In this case, the user identification information, the user attribute information, the template identification information that identifies design templates that have been viewed by the user, and the template identification information that identifies a design template used are transmitted from the user terminal apparatus 200 to the design management apparatus 10. Then, the viewing history management unit 30 manages such information as part of the viewing history information.

In accordance with the viewing history regarding viewed design templates, a recommended template providing unit 34 obtains, as a recommended template from the template storage unit 22, a design template having design feature values that are between plural design feature values associated with plural design templates that have been viewed by the user, and provides the recommended design template to the user terminal apparatus 200. Specifically, the recommended design template is transmitted to the user terminal apparatus 200 via the transmission/reception unit 40. For example, the recommended template providing unit 34 obtains, as a recommended design template from the template storage unit 22, a design template located on the design feature map between plural design templates that have been viewed by the user, and provides the recommended design template to the user terminal apparatus 200. A specific process performed by the recommended template providing unit 34 will be described in detail later.

A lacking template informing unit 36 informs the provider terminal apparatus 100 of design feature values indicating features of the design of a recommended design template in the case where no design template suitable for the recommended design template is stored in the template storage unit 22. Specifically, the design feature values are transmitted to the provider terminal apparatus 100 via the transmission/reception unit 40. For example, the lacking template informing unit 36 calculates design feature values of a recommended design template by using design feature values of plural design templates that have been viewed by the user and informs the provider terminal apparatus 100 of the calculated design feature values. A specific calculation method will be described in detail later.

In addition, the lacking template informing unit 36 may inform the provider terminal apparatus 100 that no recommended design template is stored in the template storage unit 22. In this case, information indicating that no recommended design template is stored in the template storage unit 22 is transmitted to the provider terminal apparatus 100 via the transmission/reception unit 40 and is displayed on the display unit of the provider terminal apparatus 100.

Note that the design management apparatus 10 may have a design template editing function. In this case, the design management apparatus 10 edits a design template selected by a user in accordance with an editing instruction received from the user terminal apparatus 200.

The above-described design management apparatus 10 is implemented by cooperation of hardware resources and software, for example. Specifically, the design management apparatus 10 includes a processor such as a CPU (not illustrated). The processor loads and executes a program stored in a storage device (not illustrated), and consequently functions of the design management unit 20 are implemented. The program is stored in the storage device through a storage medium such as a compact disc (CD) or a digital versatile disc (DVD) or the communication path N such as a network. Alternatively, the design management apparatus 10 may be implemented by a hardware resource such as an application specific integrated circuit (ASIC).

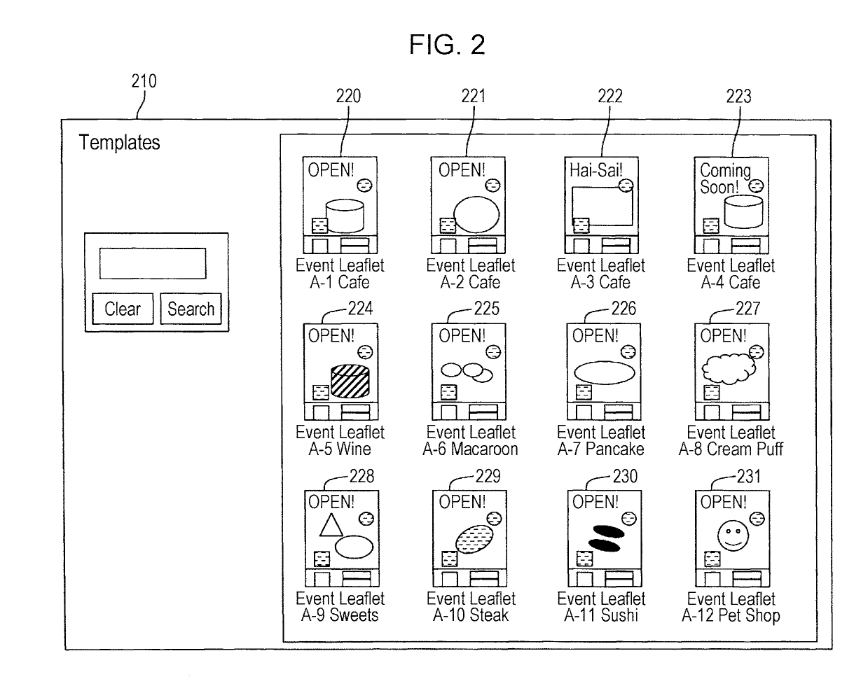

FIG. 2 illustrates an example of how design templates are displayed. For example, after a user has logged into the design management apparatus 10 by using the user terminal apparatus 200, the display control unit 28 causes the user terminal apparatus 200 to display thumbnail images of plural design templates on the display unit. For example, a screen 210 of the display unit of the user terminal apparatus 200 displays thumbnail images of design templates 220 to 231.

For example, a user selects a specific design template from among the design templates 220 to 231 and gives an instruction for display by using an operation unit of the user terminal apparatus 200. In response to the instruction for display, information indicating template identification information of the selected design template and the instruction for display is transmitted from the user terminal apparatus 200 to the design management apparatus 10. In accordance with the instruction for display, the display control unit 28 causes the user terminal apparatus 200 to display the selected design template in a larger size on the display unit. At this time, the display control unit 28 may cause the user terminal apparatus 200 to additionally display template attribute information of the selected design template on the display unit. For example, when the user selects a thumbnail image of the design template 220, the design template 220 is displayed in a larger size on the display unit of the user terminal apparatus 200. At this time, template attribute information of the design template 220 may be displayed on the display unit of the user terminal apparatus 200 along with the design template 220.

In addition, a user selects plural design templates and gives an instruction for arrangement by using the operation unit of the user terminal apparatus 200. In response to the instruction for arrangement, information indicating template identification information of the plural selected design templates and the instruction for arrangement is transmitted from the user terminal apparatus 200 to the design management apparatus 10. In accordance with the instruction for arrangement, the display control unit 28 causes the user terminal apparatus 200 to arrange and display the plural selected design templates on the display unit. At this time, the display control unit 28 may cause the user terminal apparatus 200 to additionally display template attribute information of the plural selected design templates on the display. For example, when a user selects thumbnail images of the design templates 220 and 221, the design templates 220 and 221 are arranged and displayed on the display unit of the user terminal apparatus 200. At this time, template attribute information of the design templates 220 and 221 may be displayed on the display unit of the user terminal apparatus 200 along with the design templates 220 and 221.

In addition, a user selects a design template to be used and gives instruction for editing by using the operation unit of the user terminal apparatus 200. In response to the instruction for editing, the design template to be used is displayed on the display unit of the user terminal apparatus 200, and the user is permitted to edit the design template. Then, the user edits the design template by using the operation unit of the user terminal apparatus 200. In this way, a new design is created from the design template. As described above, the design management system according to the exemplary embodiment allows a user to view individual design templates before selecting a design template to be used. Accordingly, the user selects a design template to be used after viewing the design templates.

In the exemplary embodiment, the term “a design template that has been viewed” refers to, for example, a design template that has been displayed in a larger size or design templates that have been arranged and displayed. For example, a design template that has been selected from among plural thumbnail images and has been displayed in a larger size is a design template that has been viewed by a user. In addition, plural design templates that have been selected from among plural thumbnail images and have been arranged and displayed are design templates that have been viewed by a user. The viewing history management unit 30 manages a history regarding design templates that have been viewed by each user.

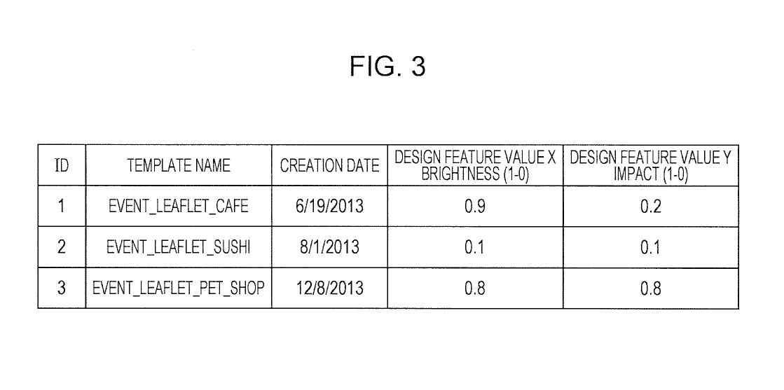

FIG. 3 illustrates an example of an attribution information table in which template attribute information is managed. The attribute information table is stored in the template storage unit 22. For example, an ID, a template name, a creation date, a design feature value X, and a design feature value Y are associated with one another in the template attribute table. The ID is template identification information that identifies a design template. The template name is a name of the design template. The creation date is the date on which the design template has been created. The design feature value X is a value indicating the lightness of color (brightness) of the design of the design template. The design feature value Y is a value indicating the impact (for example, impact given by a combination of colors) of the design template. The design feature values X and Y are merely examples, and parameters other than the lightness of color and the impact may be used as the design feature values. In addition, features of the design of design templates may be defined by using three or more design feature values.

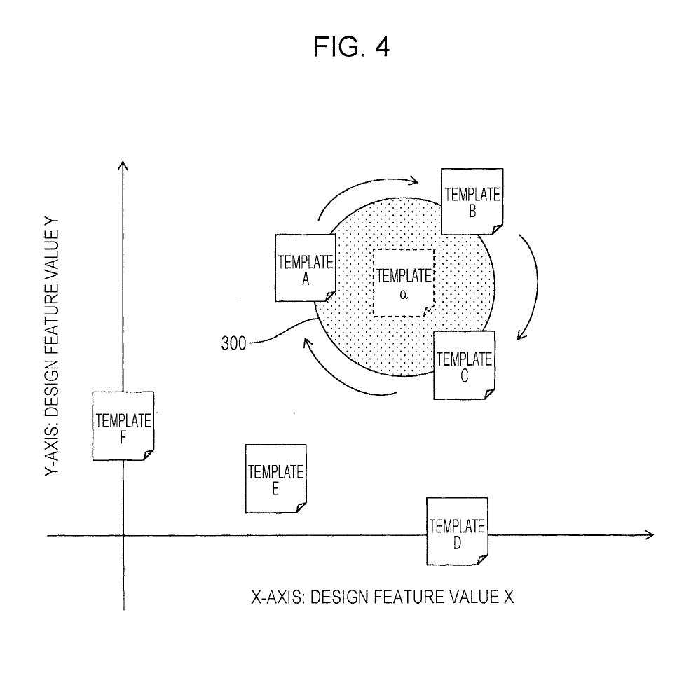

FIG. 4 illustrates an example of the design feature map. The design feature map illustrated in FIG. 4 is a two-dimensional map defined by the design feature values X and Y. The design feature value X (brightness) defines the X-axis of the design feature map, whereas the design feature value Y (impact) defines the Y-axis of the design feature map. Each design template is mapped at a position (coordinates) indicated by its design feature values X and Y on this two-dimensional design feature map. In the example illustrated in FIG. 4, design templates A to F and α are mapped on the design feature map. On the design feature map, design templates having brighter colors are mapped to the right, and design templates having darker colors are mapped to the left. In addition, on the design feature map, design templates having a stronger impact are mapped at upper positions, and design templates having a less impact are mapped at lower positions. For example, as for the design templates A and F, the design template A is brighter than the design template F and has a stronger impact than the design template F.

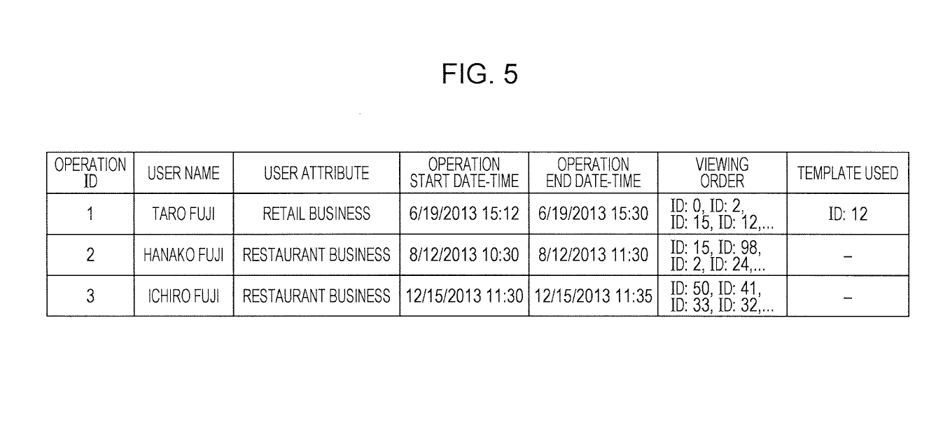

FIG. 5 illustrates an example of a viewing history table in which viewing history records are managed. The viewing history table is stored in the viewing history storage unit 32. For example, an operation ID, a user name, a user attribute, an operation start date-time, an operation end date-time, a viewing order, and a template used are associated with one another in the viewing history table.

The operation ID is an ID used to manage a history record and is given by the viewing history management unit 30. The user name is a name of a user who has viewed design templates by using the user terminal apparatus 200. The user attribute indicates, for example, business which the user is in. For example, a user enters the user name and the user attribute to the user terminal apparatus 200 and logs into the design management apparatus 10. Then, information indicating the user name and the user attribute is transmitted from the user terminal apparatus 200 to the design management apparatus 10 and is managed by the viewing history management unit 30. Note that the user attribute need not be managed as part of the viewing history. The operation start date-time is the date and time at which the user has logged into the design management apparatus 10. The operation end date-time is the date and time at which the user has logged out from the design management apparatus 10. The operation start date-time and the operation end date-time are recorded by the viewing history management unit 30.

The viewing order indicates the order in which design templates have been viewed by the user by using the user terminal apparatus 200. A field of the viewing order contains template identification information (e.g., IDs) of the design templates that have been viewed by the user and the order in which they have been viewed. The viewing order is recorded by the viewing history management unit 30.

The template used indicates a design template selected by the user as the design template used. The field of the template used contains template identification information (e.g., ID) of the selected design template. The template used is recorded by the viewing history management unit 30.

A specific example will be described by using a viewing history record assigned an operation ID “1”. The viewing history record assigned the operation ID “1” contains a user name “TARO FUJI”, a user attribute (business) “RETAIL BUSINESS”, an operation start date-time (login date-time) “6/19/2013 15:12”, and an operation end date-time (logout date-time) “6/19/2013 15:30”. The template identification information (IDs) of design templates that have been viewed by this user is “0”, “2”, “15”, “12”, and so on. The design templates have been viewed by the user in the order indicated by the template identification information (IDs). The design template assigned the design identification information (ID) “12” is selected as the design template used.

In another specific example, viewing history records assigned operation IDs “2” and “3” do not include any information at the template used field. This indicates that design templates have been viewed by the user but no design template used has been selected by the user. Reference to the viewing history allows identification of design templates that have been viewed, identification of the viewing order, and identification of whether a design template used has been selected as a result.

Referring now to FIG. 4, specific processes performed by the recommended template providing unit 34 and the lacking template informing unit 36 will be described. For example, it is assumed that the design templates A, B, and C have been viewed by a user in this order and no design template used (edited) has been selected by the user. Note that the design templates that have been viewed by the user and the viewing order are managed as the viewing history as described above.

In accordance with the viewing history records included in the viewing history table, the recommended template providing unit 34 obtains, as a recommended design template from the template storage unit 22, a design template located within an area surrounded by plural design templates that have been viewed by the user on the design feature map. For example, in the case where the design templates A, B, and C have been viewed by the user, the recommended template providing unit 34 obtains, as a recommended design template from the template storage unit 22, the design template α located within an area 300 formed by linking the design templates A, B, and C on the design feature map. At this time, the area 300 may be formed by linking the design templates A, B, and C by linear or curved lines. Alternatively, the area 300 may be formed by linking the design templates A, B, and C by linear or curved lines in accordance with the viewing order. Specifically, the area 300 may be formed by linking the design templates A and B, then the design templates B and C, and then the design templates C and A. In the example illustrated in FIG. 4, the area 300 is formed by curved lines (e.g., a circle) that pass through the design templates A, B, and C. In the case where plural design templates are located within the area 300, the recommended template providing unit 34 obtains the plural design templates as recommended design templates from the template storage unit 22. The recommended design template (e.g., the design template α) is transmitted to the user terminal apparatus 200 via the transmission/reception unit 40 and is displayed on the display unit of the user terminal apparatus 200.

In the above-described example, the user has viewed and expressed an interest in the design templates A, B, and C but has not selected any of them as the template used (edited). In such a case, it is considered that the design template α located within the area 300 is more likely to meet the needs of the user than other design templates (e.g., the design templates D, E, and F) located outside the area 300. Specifically, the design template α has the design feature values X and Y that are close to those of the design templates A, B, and C that have been viewed by the user or has the similar trend in design features. It is thus considered that the design template α is more likely to meet the needs of the user. Accordingly, the design template α is provided as the recommended design template to the user terminal apparatus 200.

In the case where the area 300 includes no design template, that is, in the case where no design template that is to be mapped within the area 300 is stored in the template storage unit 22, the lacking template informing unit 36 calculates the design feature values X and Y of the recommended design template from the design feature values X and Y of the design templates A, B, and C. Specifically, the lacking template informing unit 36 calculates an average of the design feature values X (brightness) of the design templates A, B, and C and uses the calculated average as the design feature value X of the recommended design template. Similarly, the lacking template informing unit 36 calculates an average of the design feature values Y (impact) of the design templates A, B, and C and uses the calculated average as the design feature value Y (impact) of the recommended design template. The design feature values X and Y calculated in this manner are transmitted to the provider terminal apparatus 100 via the transmission/reception unit 40 and are displayed on the display unit of the provider terminal apparatus 100. In this way, the design feature values X and Y of a design template that is considered to meet the needs of the user (attract the interest of the user) are presented to the provider. The design feature values X and Y are usable as information for assisting creation of a design template. Then, a new design template is created and is transmitted from the provider terminal apparatus 100 to the design management apparatus 10. The design template is then registered in the template storage unit 22 by the template registering unit 24.

The recommended template providing unit 34 may provide the user terminal apparatus 200 with a design template located substantially at the center or barycenter of the area 300 as a recommended design template. If no design template located substantially at the center or barycenter of the area 300 is found, the recommended template providing unit 34 may provide the user terminal apparatus 200 with a design template located within the area 300 at a position closest to the center or barycenter as the recommended design template. Alternatively, if no design template located substantially at the center or barycenter of the area 300 is found, the lacking template informing unit 36 may calculate the design feature values X and Y for the center or barycenter of the area 300 and may inform the provider terminal apparatus 100 of the calculated design feature values X and Y as the design feature values of the recommended design template. In this way, the design feature values of the recommended design template may be presented to the provider.

In another example, the recommended template providing unit 34 may provide the user terminal apparatus 200 with a design template located within the area 300 as the recommended design template in the case where the area is smaller than or equal to a reference value. In the case where the area 300 is larger than the reference value, the recommended template providing unit 34 need not provide the user terminal apparatus 200 with the recommended design template. The reference value is a predetermined value and is, for example, a value which the provider of the design template has decided upon. For example, the recommended template providing unit 34 calculates the size of the area 300. If the area 300 is smaller than or equal to a reference value (reference size), the recommended template providing unit 34 provides the user terminal apparatus 200 with a design template located within the area 300 as the recommended design template. If the area 300 is larger than the reference value, the trend in features of the design of the design templates that have been viewed by the user is not identified and the design template located within the area 300 does not necessarily meet the needs of the user. In addition, if the area 300 is larger than the reference value, the area 300 may include too many design templates. In this case, even if the design templates located within the area 300 are provided as the recommended design templates to the user, the user friendliness for selecting a design template used does not necessarily improve. Accordingly, the recommended design templates are not provided in the case where the area 300 is larger than the reference value, and the recommended design templates are provided in the case where the area 300 is smaller than or equal to the reference value. In this way, a design template that is considered to meet the needs of the user is provided. In addition, the number of design templates is reduced, and thus the user friendliness may improve.

In the case where the area 300 has a flat shape, the recommended template providing unit 34 need not provide the user terminal apparatus 200 with the recommended design template. In the case where the area 300 has a flat shape, the trend in design feature values of the design templates that have been viewed by the user is not identified. Accordingly, it may be inappropriate to provide a design template located within the area 300 as the recommended design template.

In another example, the recommended template providing unit 34 may provide the user terminal apparatus 200 with design templates located within the area 300 as recommended design templates in the case where the number of design templates located within the area 300 is less than or equal to a reference value. In the case where the number of design templates located within the area 300 is greater than the reference value, the recommended template providing unit 34 need not provide the user terminal apparatus 200 with the recommended design templates. The reference value is a predetermined value and is, for example, a value decided upon by the provider of design templates. In the case where the number of design templates located within the area 300 is greater than the reference value, even if design templates located within the area 300 are provided to the user as recommended design templates, too many design templates are provided, which does not necessarily make it easier for the user to select a design template. For this reason, recommended templates are not provided in the case where the number of design templates located within the area 300 is greater than the reference value. In contrast, recommended design templates are provided to the user terminal apparatus 200 in the case where the number of design templates located within the area 300 is less than or equal to the reference value. With this configuration, the number of design templates is reduced, and thus the user friendliness may improve.

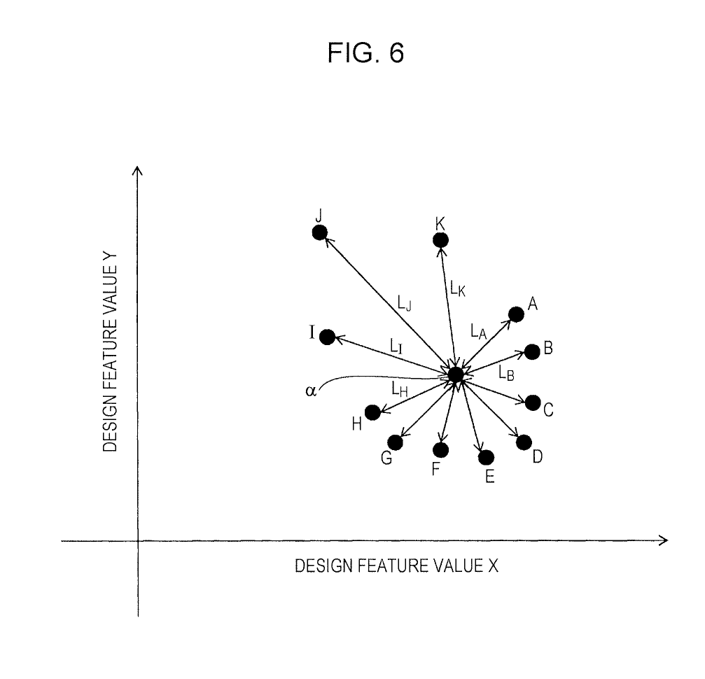

In another example, the recommended template providing unit 34 may provide the user terminal apparatus 200 with, as the recommended design template, a design template located within the area 300 at a position (minimum position) at which the sum of the distances from the minimum position to the positions of the design templates A, B, and C is minimized. FIG. 6 illustrates a specific example of this process in which it is assumed that design templates A to K have been viewed by the user and that no design template has been selected by the user as the design template used. In this case, the recommended template providing unit 34 provides the user terminal apparatus 200 with, as the recommended design template, the design template α which is located at a position at which the sum (=L_{A}+L_{B}+. . . +L_{J}+L_{K}) of the distances from the minimum position to the positions of the design templates A to K is minimized within an area surrounded by the design templates A to K. If no design template is found at the minimum position, the recommended template providing unit 34 may provide the user terminal apparatus 200 with, as the recommended design template, a design template located at a position that is closest to the minimum position. Alternatively, if no design template is found at the minimum position, the lacking template informing unit 36 may inform the provider terminal apparatus 100 of the design feature values X and Y at the minimum position as the design feature values of the recommended design template.

The minimum position is a position at which the sum of the distances from the minimum position to the positions of the design templates A to K is minimized and thus is located closer to a part where the design templates that have been viewed by the user are densely located than a part where the design templates are sparsely located. For example, a density of design templates is high at a part where the design templates A to H are located, whereas a density of design templates is low at a part where design templates I to K are located. In such a case, the minimum position is located closer to the part where the design templates A to H are located than the part where the design templates I to K are located. Accordingly, features of design templates A to H are more reflected in the design template α located at the minimum position than features of the design templates I to K. That is, the design template α has design features that are closer to those of the design templates A to H than those of the design templates I to K. It is considered that the design templates A to H that are located at the part where design templates that have been viewed by the user are located at a high density are a design template group closer to the needs of the user than the design templates I to K located at a low-density part. For this reason, by providing the user terminal apparatus 200 with the design template α located at the minimum position, a design template considered to meet the needs of the user is provided to the user.

The recommended template providing unit 34 may provide the user terminal apparatus 200 with thumbnail images or template identification information of recommended design templates. In this case, thumbnail images or template identification information of recommended design templates are transmitted to the user terminal apparatus 200 via the transmission/reception unit 40 and are displayed on the display unit of the user terminal apparatus 200. In response to a user request for acquisition of a recommended design template entered to the user terminal apparatus 200, information indicating the request is transmitted from the user terminal apparatus 200 to the design management apparatus 10. In response to the request, the recommended template providing unit 34 provides the user terminal apparatus 200 with the recommended design template. In this way, editing of the recommended design template is permitted in the user terminal apparatus 200.

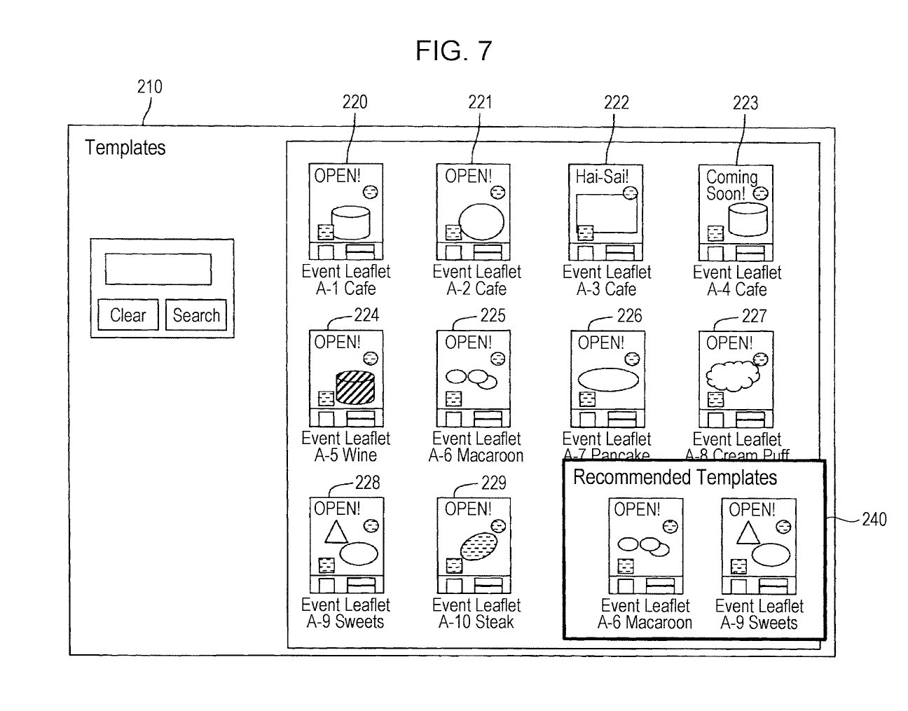

FIG. 7 illustrates an example of how recommended design templates are displayed on the display unit of the user terminal apparatus 200. For example, the case of displaying thumbnail images of recommended design templates will be described. For example, when thumbnail images of recommended design templates are transmitted from the design management apparatus 10 to the user terminal apparatus 200, a recommended design template display window 240 is displayed in the screen 210 of the display unit of the user terminal apparatus 200, and the thumbnail images of the recommended design templates are displayed within the recommended design template display window 240. In the example illustrated in FIG. 7, thumbnail images of two recommended design templates are displayed within the recommended design template display window 240. The user selects one of the thumbnail images of the recommended design templates and gives an instruction for display to the user terminal apparatus 200. In response to the instruction for display, information indicating template identification information of the selected recommended design template and the instruction for display is transmitted from the user terminal apparatus 200 to the design management apparatus 10. In accordance with the instruction for display, the display control unit 28 causes the user terminal apparatus 200 to display the recommended design template in a larger size on the display unit. At this time, the display control unit 28 may cause the user terminal apparatus 200 to additionally display template attribute information of the recommended design template on the display unit. The recommended design template display window 240 and thumbnail images of the recommended design templates are displayed on the screen 210 when the user is viewing thumbnail images of design templates or is viewing design templates, for example. Note that, instead of providing the user terminal apparatus 200 with thumbnail images of the recommended design templates, the recommended design templates may be provided to and displayed on the user terminal apparatus 200.

The viewing history management unit 30 may provide the provider terminal apparatus 100 with information contained in the viewing history table. For example, information contained in the viewing history table is transmitted from the design management apparatus 10 to the provider terminal apparatus 100 via the transmission/reception unit 40 and is displayed on the display unit of the provider terminal apparatus 100. For example, the viewing history table illustrated in FIG. 5 is displayed on the display unit of the provider terminal apparatus 100.

The viewing history table provided to the provider terminal apparatus 100 allows the provider to know the following information. For example, the viewing order allows the provider to know the order in which design templates have been viewed by the user. The template used allows the provider to know whether a specific design template has been selected as the template used and to know which design template has been selected as the template used by the user. The operation start date-time and the operation end date-time allow the provider to know the period for which the design management system has been used. For example, the provider is allowed to know the period required to select the design template used. The user attribute allows the provider to know which type of design template attracts an interest of users who are in certain business. As described above, management of the viewing history allows identification of the order in which design templates have been viewed, identification of a design template that has been selected as the template used as a result of the viewing, and a period of time required to make the selection. Such a viewing history is usable as a reference material by the provider to create and provide design templates. The provider creates and provides design templates with reference to the viewing history. In this way, design templates that meet the needs of the user may be provided.

The viewing history management unit 30 may extract viewing history records for which a period from the operation start date-time to the operation end date-time (i.e., a period of use) is longer than or equal to a predetermined reference period and may provide the provider terminal apparatus 100 with information indicating the extracted viewing history records. The information indicating the extracted viewing history records is transmitted to the provider terminal apparatus 100 via the transmission/reception unit 40 and is displayed on the display unit of the provider terminal apparatus 100. In the case where the period of use is longer than or equal to the predetermined reference period, it is considered that the user has selected a design template after careful consideration. Accordingly, by providing the provider terminal apparatus 100 with such viewing history information, the provider is provided with information regarding the design templates considered to have especially attracted the user's interest.

The viewing history management unit 30 may provide the provider terminal apparatus 100 with viewing history records containing a user attribute specified by the provider. For example, the provider enters information indicating a user attribute by using the provider terminal apparatus 100. In response to the input, the information indicating the user attribute is transmitted from the provider terminal apparatus 100 to the design management apparatus 10. The viewing history management unit 30 extracts viewing history records containing the user attribute and provides the provider terminal apparatus 100 with information indicating the extracted viewing history records. In this case, the information indicating the extracted viewing history records is transmitted to the provider terminal apparatus 100 via the transmission/reception unit 40 and is displayed on the display unit of the provider terminal apparatus 100. This configuration allows the provider to know a design template that has attracted the interest of users who are in certain business. The viewing history records associated with certain business is usable as a reference material when design templates for the specific business are created. For example, in the case where design templates for restaurant business are created, design templates are created by the provider with reference to viewing history records of users who are in restaurant business. In this way, design templates that meet the needs of users who are in restaurant business may be created.

In addition, because template attribute information of individual design templates contains design feature values, the viewing history allows identification of design feature values of design templates that have been viewed by the user. That is, design feature values of design templates that have been viewed by the user are identified. Accordingly, providing the provider terminal apparatus 100 with the viewing history allows the provider to know the design feature values of the design templates that have been viewed by the user. This configuration allows the provider to know the trend in the design that has been viewed by the user.

The viewing history management unit 30 may provide the provider terminal apparatus 100 with a design feature map showing design templates that have been viewed by the user in an identifiable manner. For example, the viewing history management unit 30 may provide the provider terminal apparatus 100 with a design feature map showing only the design templates A, B, and C that have been viewed by the user from the design feature map illustrated in FIG. 4. Alternatively, the viewing history management unit 30 may perform display so that the design templates A, B, and C that have been viewed by the user are distinguished from the other design templates on the design feature map that shows the design templates A to F and α. For example, the viewing history management unit 30 may display the design templates A, B, and C in a specific color or by surrounding them with a line on the design feature map. The viewing history management unit 30 may display the area 300 in a specific color or by surrounding the area 300 using a line on the design feature map. Data of such a design feature map is transmitted from the design management apparatus 10 to the provider terminal apparatus 100 via the transmission/reception unit 40 and is displayed on the display unit of the provider terminal apparatus 100. Because design templates that have been viewed by the user are mapped on the design feature map, the design feature map allows the provider to intuitively know the trend in design templates that have been viewed by the user.

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A design management apparatus comprising:
a management unit that manages a history regarding a plurality of design templates which have been viewed by a user, each of the plurality of design templates being associated with a plurality of design feature information items that indicate a plurality of types of features in design; and
an output unit that outputs a recommended design template in accordance with the history, the recommended design template being a design template having feature values which are between feature values of the plurality of types of features indicated by the plurality of design feature information items associated with the plurality of design templates which have been viewed by the user.

2. The design management apparatus according to claim 1, wherein the output unit outputs, as the recommended design template, a design template located within an area surrounded by the plurality of design templates which have been viewed by the user on a design feature map on which design templates are mapped in accordance with the plurality of design feature information items.

3. The design management apparatus according to claim 2, wherein in a case where the area surrounded by the plurality of design templates which have been viewed by the user is smaller than or equal to a reference value, the output unit outputs a design template located within the area on the design feature map as the recommended design template.

4. The design management apparatus according to claim 2, wherein the output unit outputs, as the recommended design template, a design template located substantially at the center or barycenter of the area surrounded by the plurality of design templates which have been viewed by the user on the design feature map.

5. The design management apparatus according to claim 2, wherein the output unit outputs, as the recommended design template, a design template that is located within the area surrounded by the plurality of design templates which have been viewed by the user on the design feature map and that is located at a position at which the sum of distances from positions where the plurality of design templates which have been viewed by the user are mapped to the position is minimized.

6. The design management apparatus according to claim 1, further comprising
a design feature information output unit that determines design feature information items indicating features in design of the recommended design template from the design feature information items of the plurality of design templates which have been viewed by the user and that outputs the determined design feature information items, in a case where a design template suitable for the recommended design template is not found.

7. A design management method comprising:
managing a history regarding a plurality of design templates which have been viewed by a user, each of the plurality of design templates being associated with a plurality of design feature information items that indicate a plurality of types of features in design; and
outputting a recommended design template in accordance with the history, the recommended design template being a design template having feature values which are between feature values of the plurality of types of features indicated by the plurality of design feature information items associated with the plurality of design templates which have been viewed by the user.

8. A non-transitory computer readable medium storing a program causing a computer to execute a process for design management, the process comprising:
managing a history regarding a plurality of design templates which have been viewed by a user, each of the plurality of design templates being associated with a plurality of design feature information items that indicate a plurality of types of features in design; and
outputting a recommended design template in accordance with the history, the recommended design template being a design template having feature values which are between feature values of the plurality of types of features indicated by the plurality of design feature information items associated with the plurality of design templates which have been viewed by the user.
